(19) United States
(12) Patent Application Publication
(10) Pub. No.: US 2023/0251517 A1
(43) Pub. Date: Aug. 10, 2023

(54) TOUCH PANEL AND TOUCH DISPLAY DEVICE

(71) Applicant: HUIZHOU CHINA STAR OPTOELECTRONICS TECHNOLOGY CO., LTD., Huizhou (CN)

(72) Inventors: Chongming Hu, Huizhou (CN); Chingyuan Cheng, Huizhou (CN)

(73) Assignee: HUIZHOU CHINA STAR OPTOELECTRONICS TECHNOLOGY CO., LTD., Huizhou (CN)

(21) Appl. No.: 16/964,075

(22) PCT Filed: Jul. 9, 2020
(86) PCT No.: PCT/CN2020/101087

§ 371 Date: Jul. 22, 2020

(30) Foreign Application Priority Data
Jun. 12, 2020 (CN) 202010537290.9

(51) Int. Cl. G02F 1/1333; G02F 1/1335; G02F 1/1339; G06F 3/041

(52) U.S. Cl. CPC G02F 1/13338; G02F 1/133512; G02F 1/1339; G06F 3/041; G06F 2203/04107

(57) ABSTRACT

A touch panel and a touch display device are provided. The touch panel includes a package cover plate and a touch substrate disposed opposite to each other, and a connection layer disposed between the package cover plate and the touch substrate. The touch substrate comprises a substrate, and a touch trace layer disposed on a side of the substrate close to the package cover plate. A light shielding layer is disposed on a side of the package cover plate close to the touch substrate. An orthographic projection of the light shielding layer projected on the substrate at least partially overlaps an orthographic projection of the touch trace layer projected on the substrate.

### FIELD OF INVENTION

This disclosure relates to touch display technology, and more particularly, to a touch panel and a touch display device.

### BACKGROUND OF INVENTION

With the development of display technology, touch display has become the focus of the industry.

At present, a touch screen mainly includes a display panel and a touch panel. Touch metal wires in the touch panel may reflect light in a bright light condition, thereby reducing the contrast of the overall display effect of the touch screen and affecting the display effect of the touch screen. In addition, in the touch panel, a protective cover plate and the touch substrate are combined by an optical glue full bonding process. However, the full bonding process has high requirements for the dust-free level and glue control, the yield of the combination of protective cover and touch substrate cannot be improved. Also, the labor cost is greatly increased for cleaning the residual glue or overflow glue.

### SUMMARY OF INVENTION

The disclosure provides a touch panel and a touch display device for solving the drawbacks that the reflection of touch metal wires in the conventional touch display device which causes the contrast of the overall display of the touch display device is reduced, and the display effect of the touch display device is affected.

In order to solve the above-mentioned drawbacks, the disclosure provides a technical solution as follow.

The disclosure provides a touch panel. The touch panel comprises a package cover plate and a touch substrate disposed opposite to each other, and a connection layer disposed between the package cover plate and the touch substrate.

The touch substrate comprises a substrate, and a touch trace layer disposed on a side of the substrate close to the package cover plate, and a light shielding layer is disposed on a side of the package cover plate close to the touch substrate.

An orthographic projection of the light shielding layer on the substrate at least partially covers an orthographic projection of the touch trace layer on the substrate.

In the touch panel of the disclosure, the touch trace layer comprises at least one metal trace, the light shielding layer comprises at least one light shielding strip corresponding to the metal trace, an orthographic projection of the light shielding strip on the substrate at least partially covers an orthographic projection of the metal trace on the substrate.

In the touch panel of the disclosure, an orthographic projection of a center line of the light shielding strip on the substrate overlaps an orthographic projection of a center line of the metal trace on the substrate.

In the touch panel of the disclosure, the orthographic projection of the light shielding strip on the substrate overlaps the orthographic projection of the metal trace on the substrate.

In the touch panel of the disclosure, the connection layer comprises a first sealant and a transparent filling layer, and the package cover plate, the touch substrate, and the first sealant enclose a first cavity, and the transparent filling layer is disposed in the first cavity.

In the touch panel of the disclosure, a material of the transparent filling layer is liquid crystal.

In the touch panel of the disclosure, the touch panel comprises a touch display area and a non-display area disposed around the touch display area, the light shielding layer is disposed in the touch display area, a black blocking wall positioned in the non-display area is disposed on the side of the package cover plate close to the touch substrate, an orthographic projection of the black blocking wall on the substrate covers an orthographic projection of the first sealant on the substrate, a material of the light shielding layer is the same as a material of the black blocking wall, and the light shielding layer and the black blocking wall forms an integrally molded structure.

In the touch panel of the disclosure, a thickness of the package cover plate is the same as a thickness of the substrate.

The disclosure further provides a touch display device. The touch display device comprises a display panel, and a touch panel as mentioned in the above embodiment. The touch panel is disposed on one side of the display panel.

In the touch display device of the disclosure, a second sealant is disposed between the display panel and the touch panel, the display panel, the touch panel and the second sealant are enclosed to form a second cavity, and an air pressure in the second cavity is less than an atmospheric pressure outside the second cavity.

In the touch display device of the disclosure, the display panel is curved in an arc shape, the touch panel is disposed on a concave side of display panel that is in the arc shape and is corresponding to a shape of the touch panel.

In the touch display device of the disclosure, a thickness of the touch panel is equal to a thickness of the display panel.

In the touch display device of the disclosure, the second cavity is in a vacuum state.

In the touch display device of the disclosure, the touch trace layer comprises at least one metal trace, the light shielding layer comprises at least one light shielding strip corresponding to the metal trace, an orthographic projection of the light shielding strip on the substrate at least partially covers an orthographic projection of the metal trace on the substrate.

In the touch display device of the disclosure, an orthographic projection of a center line of the light shielding strip on the substrate overlaps an orthographic projection of a center line of the metal trace on the substrate.

In the touch display device of the disclosure, the orthographic projection of the light shielding strip on the substrate overlaps the orthographic projection of the metal trace on the substrate.

In the touch display device of the disclosure, the connection layer comprises a first sealant and a transparent filling layer, and the package cover plate, the touch substrate, and the first sealant enclose a first cavity, and the transparent filling layer is disposed in the first cavity.

In the touch display device of the disclosure, a material of the transparent filling layer is liquid crystal.

In the touch display device of the disclosure, the touch panel comprises a touch display area and a non-display area disposed around the touch display area, the light shielding layer is disposed in the touch display area, a black blocking wall positioned in the non-display area is disposed on the side of the package cover plate close to the touch substrate, an orthographic projection of the black blocking wall on the substrate covers an orthographic projection of the first sealant on the substrate, a material of the light shielding layer is the same as a material of the black blocking wall, and the light shielding layer and the black blocking wall forms an integrally molded structure.

In the touch display device of the disclosure, a thickness of the package cover plate is equal to a thickness of the substrate.

Advantageous effects of the disclosure are as follows. In the disclosure, the light shielding layer is disposed on the package cover plate, and the orthographic projection of the light shielding layer projected on the substrate at least partially overlaps the orthographic projection of the touch trace layer projected on the substrate, so as to block the light reflected by the touch trace layer by the light shielding layer. The drawbacks that the contrast of the overall display of the touch display device to be decreased caused by the reflection of the touch trace layer in the touch panel can be prevented. The overall display effect of the touch display device is improved.

### DESCRIPTION OF DRAWINGS

In order to more clearly illustrate the embodiments of the disclosure or the technical solutions in the prior art, the following briefly introduces the accompanying drawings used in the embodiments. Obviously, the drawings in the following description merely show some of the embodiments of the disclosure. As regards one of ordinary skill in the art, other drawings can be obtained in accordance with these accompanying drawings without making creative efforts.

FIG. 1 is a structural schematic diagram of a touch panel in an embodiment of this disclosure.

FIG. 2 is a top schematic diagram of a touch trace layer in an embodiment of this disclosure.

FIG. 3 is a top schematic diagram of a light shielding layer in an embodiment of this disclosure.

FIG. 4 is a schematic diagram of a first structure of a light shielding strip and a metal trace in an embodiment of this disclosure.

FIG. 5 is a schematic diagram of a second structure of a light shielding strip and a metal trace in an embodiment of this disclosure.

FIG. 6 is a schematic diagram of a third structure of a light shielding strip and a metal trace in an embodiment of this disclosure.

FIG. 7 is a schematic diagram of a first structure of a touch display device in an embodiment of this disclosure.

FIG. 8 is a schematic diagram of a second structure of a touch display device in an embodiment of this disclosure.

### DETAILED DESCRIPTION OF PREFERRED EMBODIMENTS

This description of the exemplary embodiments is intended to be read in connection with the accompanying drawings, which are to be considered part of the entire written description. In the description, terms such as “upper”, “lower”, “front”, “back”, “left”, “right”, “inside”, “outside”, and “side”, as well as derivatives thereof, should be construed to refer to the orientation as then described or as shown in the drawing under discussion. These terms are for convenience of description and do not require that the apparatus be constructed or operated in a particular orientation, and do not limit the scope of the disclosure. Referring to the drawings of the disclosure, similar components are labeled with the same number.

In the description of this disclosure, it should be understood that the terms “center”, “longitudinal”, “transverse”, “length”, “width”, “thickness”, “upper”, “lower”, “front”, “back, “left”, “right”, “vertical”, “horizontal”, “top”, “bottom”, “inner”, “outer”, “clockwise”, “counterclockwise” etc. for indicating orientation or positional relationship are based on the orientation or positional relationship shown in the drawings. The above-mentioned terms are only for the convenience of describing the disclosure and for simplifying the description, rather than indicating or implying that the device or element referred to must have a specific orientation, be constructed and operated in a specific orientation. Therefore, it cannot be understood as a limitation to this disclosure. In addition, the terms “first” and “second” are used for description purposes only, and cannot be understood as indicating or implying relative importance or implicitly indicating the disclosed number of technical features. Thus, features defined as “first” and “second” may explicitly or implicitly include one or more of the features. In the description of this disclosure, the meaning of “plurality” is two or more, unless otherwise specifically limited.

In the description of this disclosure, it should be noted that, unless otherwise clearly specified and limited, the terms “installation”, “connecting”, and “connection” should be understood in a broad sense. For example, it can be fixed connection or detachable connection, or integrally connection, or mechanical connection, or electrical connection, or communicate with each other, it also can be directly connected, or can be indirectly connected through an intermediary, or it can be the connection between two elements or the interaction of two elements. For those of ordinary skill in the art, the specific meaning of the above terms in the disclosure can be understood according to specific situations.

In this disclosure, unless otherwise clearly specified and defined, the first feature “above” or “below” the second feature may include the direct contact of the first and second features, or may include the first and second features not directly contact but through another feature between them. Moreover, the first feature is “on”, “above” and “upper” the second feature includes that the first feature is directly above and obliquely above the second feature, or simply means that a horizontal height of the first feature is higher than a horizontal height of the second feature. The first feature is “down”, “below” and “lower” the second feature includes that the first feature is directly below and obliquely below the second feature, or simply means that a horizontal height of the first feature is lower than a horizontal height of the second feature.

The following disclosure provides many different embodiments or examples for implementing different structures of the disclosure. In order to simplify the description of the disclosure, the elements and configuration of specific examples are described below. Of course, the embodiments are only examples, and are not to limit this disclosure. In addition, the disclosure can repeat reference numerals and/or reference letters in different examples for the purpose of simplicity and clarity, which in itself does not indicate the relationship between the various disclosed embodiments and/or configurations. In addition, the disclosure provides examples of various specific processes and materials, but one having ordinary skill in the art can understand that other processes and/or the use of other materials can be applied.

The technical solution of the disclosure is now described in combination with specific embodiments.

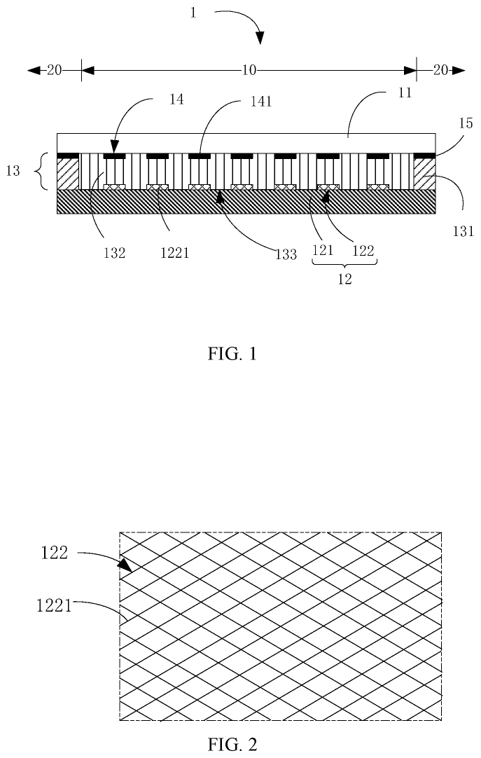

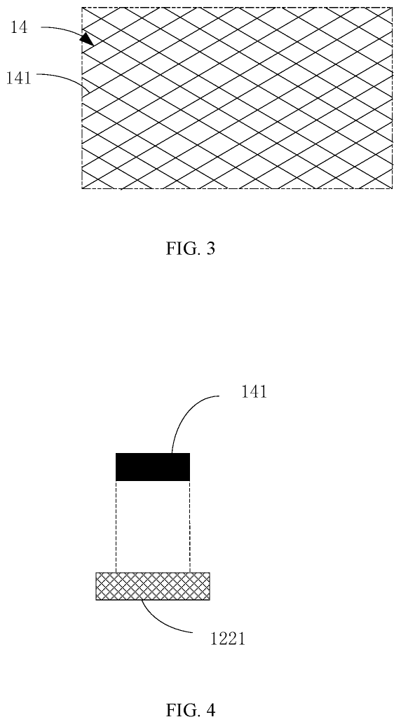

Referring to FIG. 1 to FIG. 6, the disclosure provides a touch panel 1, which comprises a package cover plate 11 and a touch substrate 12 disposed opposite each other. A connection layer 13 is disposed between the package cover plate 11 and the touch substrate 12.

The touch substrate 12 comprises a substrate 121, and a touch trace layer 122 disposed on a side of the substrate 121 close to the package cover plate 11. A light shielding layer 14 is disposed on a side of the package cover plate 11 close to the touch substrate 12.

An orthographic projection of the light shielding layer 14 on the substrate 121 at least partially covers an orthographic projection of the touch trace layer 122 on the substrate 121.

It can be understood that the touch panel 1 includes a package cover plate 11 and a touch substrate 12 disposed opposite each other. The touch substrate 12 includes a substrate 121 and a touch trace layer 122 disposed on a side of the substrate 121 close to the package cover plate 11. Under conditions such as strong light irradiation, the light is reflected by the touch trace layer 122 in the touch panel 1, thereby reducing the contrast of the overall display of the touch display and affecting the overall display effect. In this embodiment, the light shielding layer 14 is disposed on the package cover plate 11, and the orthographic projection of the light shielding layer 14 on the substrate 121 at least partially covers the orthographic projection of the touch trace layer 122 on the substrate 121, so as to block the light reflected by the touch trace layer 122 by the light shielding layer 14. The reduction in contrast of the overall display of the touch display device caused by the reflection of the touch trace layer 122 in the touch panel 1 can be prevented. The overall display effect of the touch display device is improved.

As mentioned above, in this embodiment, the orthographic projection of the light shielding layer 14 projected on the substrate 121 partially overlaps the orthographic projection of the touch trace layer 122 projected on the substrate 121, or completely covers the orthographic projection of the touch trace layer 122 on the substrate 121, thereby at least partially blocking the reflected light of the touch trace layer 122. Obviously, under the condition of blocking the transmission of light, a material of the light shielding layer 14 can be selected according to actual needs, and is not limited herein.

Referring to FIG. 1 to FIG. 6, in this embodiment, the touch trace layer 122 comprises at least one metal trace 1221, the light shielding layer 14 comprises at least one light shielding strip 141 corresponding to the metal trace. An orthographic projection of the light shielding strip 141 projected on the substrate 121 at least partially overlaps an orthographic projection of the metal trace 1221 projected on the substrate 121. It can be understood that the touch trace layer 122 is a patterned metal circuit, which can specifically include a metal trace 1221, such as a transmitting electrode, a receiving electrode, etc. In this embodiment, the pattern of the light shielding layer 14 can be the same as that of the touch trace layer 122. Each of the metal traces 1221 in the touch trace layer 122 corresponds to one of the light shielding strips 141, so that each of the metal traces 1221 is at least partially covered by the light-shielding strip 141. Therefore, the light shielding layer 14 can uniformly block the reflected light of the touch trace layer 122.

Referring to FIG. 4 to FIG. 6, in this embodiment, an orthographic projection of a center line of the light shielding strip 141 projected on the substrate 121 overlaps an orthographic projection of a center line of the metal trace 1221 projected on the substrate 121. It can be understood that in one of the metal trace 1221 and the light shielding strip 141 corresponding to the metal trace 1221, a width of the light shielding strip 141 can be greater than, equal to or less than a width of the metal trace 1221. Obviously, when the orthographic projection of the center line of the light shielding strip 141 projected on the substrate 121 overlaps the orthographic projection of the center line of the metal trace 1221 projected on the substrate 121, whether the width of the light shielding strip 141 can be greater than, equal to or less than the width of the metal trace 1221, a desirable display effect can be achieved.

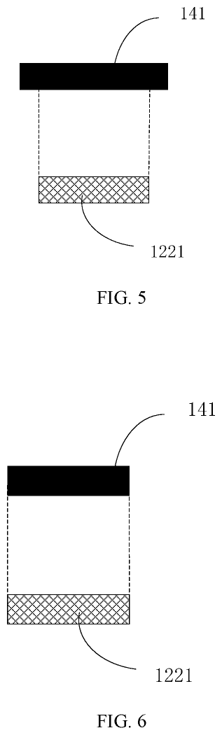

As mentioned above, referring to FIG. 4, in this embodiment, when the width of the light shielding strip 141 is less than the width of the metal trace 1221, the orthographic projection of the center line of the light shielding strip 141 projected on the substrate 121 overlaps the orthographic projection of the center line of the metal trace 1221 projected on the substrate 121. It can ensure that the light shielding strip 141 covers the middle of the metal trace 1221. Although both sides of the metal trace 1221 that are not blocked still reflect light, light-dark-light display stripes are generally presented. Besides, the width of the metal trace 1221 and the width of the light shielding strip 141 are relatively small, which reduce the resolution of the light stripe reflected by the metal trace 1221. Obviously, this structure can also improve the contrast of the touch display device comprising the touch panel 1. Also, with this structure, the light shielding layer 14 does not affect the overall transmittance of the touch display device. Referring to FIG. 5, when the width of the light shielding strip 141 is greater than the width of the metal trace 1221, the orthographic projection of the center line of the light shielding strip 141 projected on the substrate 121 overlaps the orthographic projection of the center line of the metal trace 1221 projected on the substrate 121. It can ensure that the light shielding strip 141 completely shields the metal trace 1221, and two widths of two portions of the light shielding strip 141 beyond both sides of the metal trace 1221 are equal, so that the light shielding strip 141 also has a certain blocking effect on the reflected inclined light by the metal trace 1221. Certainly, in order to prevent the width of the light shielding strip 141 from being too large and affecting the overall transmittance rate of the touch display device, the width of the light shielding strip 141 can be set according to actual needs.

Referring to FIG. 6, it should be noted that when the width of the light shielding strip 141 is equal to the width of the metal trace 1221, the orthographic projection of the center line of the light shielding strip 141 projected on the substrate 121 overlaps the orthographic projection of the center line of the metal trace 1221 projected on substrate 121. At this time, the orthographic projection of the light shielding strip 141 projected on the substrate 121 overlaps the orthographic projection of the metal trace 1221 projected on the substrate 121. The light shielding strip 141 completely blocks the metal trace 1221. Obviously, this structure can completely block the metal trace 1221 without affecting the overall transmittance rate of the touch display device.

Referring to FIG. 1, in this embodiment, the connection layer 13 comprises a first sealant 131 and a transparent filling layer 132. The package cover plate 11, the touch substrate 12, and the first sealant 131 enclose a first cavity 133, and the transparent filling layer 132 is disposed in the first cavity 133. It can be understood that in a conventional touch panel, a protective cover plate and a touch substrate are combined by an optical glue full bonding process. However, the full bonding process has high requirements for the dust-free level and glue control, the yield of the combination of protective cover and touch substrate cannot be improved. Also, the labor cost is greatly increased for cleaning the residual glue or overflow glue. In this embodiment, the package cover plate 11 is aligned with the touch substrate 12. The package cover plate 11 and the touch substrate 12 are bonded by the first sealant 131. A transparent filling layer 132 is filled in the first cavity 133 enclosed by the package cover plate 11, the touch base plate 12, and the first sealant 131, so that the touch panel 1 forms a box structure similar to the display panel. It prevents the high requirements and environment requirements on the optical glue full bonding process for bonding the protective cover plate and the touch base plate. In addition, the touch panel 1 can form a cell structure similar to that of the display panel. Based on the liquid crystal cell assembly technology in the conventional LCD panel, the device and related materials for manufacturing the liquid crystal display panel are used for manufacturing the touch panel to facilitate large-scale production.

As mentioned above, a conventional touch display screen is mainly comprises a display panel and a touch panel 1 with a protective cover plate. Due to the limitation of physical strengthening, a thickness of protective cover plate is at least greater than 3.0 mm, which is much greater than a thickness of the display panel, such as a LCD panel. In addition to the protective cover plate, the touch panel 1 further includes a touch substrate 12 and an optical adhesive layer for bonding the protective cover plate and the touch substrate 12 to further increase the thickness difference between the display panel and the touch panel 1. When the display panel and the touch panel 1 undergo a vacuum edge lamination, the relatively thin display panel is bent and deformed toward the touch substrate 12. In addition, the touch panel 1 is also limited and bended due to a full-surface optical glue disposed between the protective cover plate and the touch base plate 12. In this embodiment, the package cover plate 11 is aligned with the touch substrate 12. The package cover plate 11 and the touch substrate 12 are bonded by the first sealant 131. A transparent filling layer 132 is filled in the first cavity 133 enclosed by the package cover plate 11, the touch base plate 12, and the first sealant 131, so that the touch panel 1 forms a box structure similar to the display panel. It solves a problem that the touch panel 1 is limited and bended due to being disposed the full-surface optical glue. In addition, it is obvious that the thinner the touch panel 1 is, the more easily the touch panel 1 is bent. The touch panel 1 with the box structure can greatly reduce the thickness of the touch panel 1, so as to prevent the display panel from excessive bending and deformation towards the touch base plate 12 when the vacuum edge lamination is performed.

In one embodiment, the material of the transparent filling layer 132 is not limited on the basis of meeting the transparency requirement, such as transparent resin, liquid crystal and other materials. Specifically, in this embodiment, the material of the transparent filling layer 132 is liquid crystal. Obviously, the liquid crystal material is commonly used in the application of the liquid crystal display panel, so it is more convenient to obtain the material for manufacturing the touch panel 1, and realize the large-scale production at a lower cost. In addition, the material of the transparent filling layer 132 is liquid crystal, which is more convenient for bending of the touch panel 1 to form a touch panel 1 with a curved surface structure.

Referring to FIG. 1, in this embodiment, the touch panel 1 comprises a touch display area 10 and a non-display area 20 disposed around the touch display area 10. The light shielding layer 14 is disposed in the touch display area 10, a black blocking wall 15 positioned in the non-display area 20 is disposed on the side of the package cover plate 11 close to the touch substrate 12. An orthographic projection of the black blocking wall 15 projected on the substrate 121 overlaps an orthographic projection of the first sealant 131 projected on the substrate 121. A material of the light shielding layer 14 is the same as a material of the black blocking wall 15, and the light shielding layer 14 and the black blocking wall 15 forms an integrally molded structure. Obviously, the material of the light shielding layer 14 is set to be the same as the material of the black blocking wall 15, and the light shielding layer 14 and the black blocking wall 15 are formed an integrally molded structure. The light shielding layer 14 is manufactured by the same manufacturing process, without additional manufacturing process, which greatly saves manufacturing costs and improves manufacturing efficiency.

As mentioned above, referring to FIG. 1, in this embodiment, an orthographic projection of the black blocking wall 15 on the touch substrate 12 covers an orthographic projection of the first sealant 131 on the touch substrate 12. That is, the black blocking wall 15 is disposed along a periphery of the package cover plate 11 close to one side of the touch substrate 12, and completely covers the first sealant 131. After the touch panel 1 and the display panel are assembled, the black blocking wall 15 is also configured for blocking the light in a surrounding area of the touch panel 1.

In one embodiment, a thickness of the package cover plate 11 is the same as a thickness of the substrate 121. It can be understood that in the touch panel 1 with a box structure, the thickness of the package cover plate 11 can be far less than a thickness of a conventional protective cover plate with a thickness of at least 3.0 mm. A thickness of the package cover plate 11 can be less than 0.5 mm. The touch substrate 12 includes the substrate 121 and the touch trace layer 122 disposed on the substrate 121. The package cover plate 11 can use a glass substrate 121 with the same material and thickness as the substrate 121. In particular, the package cover plate 11 is a glass substrate with a thickness of 0.4 mm. Obviously, a material of the glass substrate is commonly used in applying for substrates on both sides of display panel, so that it is more convenient to obtain the material for manufacturing the touch panel 1, and realize the large-scale production at a lower cost.

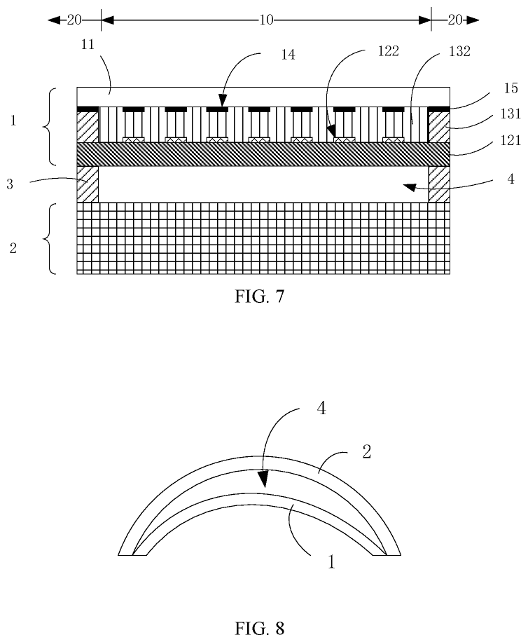

Referring to FIG. 7, the disclosure further provides a touch display device, which comprises a display panel 2 and a touch panel 1 as mentioned above. The touch panel 1 is disposed on one side of the display panel 2. Specifically, a second sealant 3 is disposed between the display panel 2 and the touch panel 1. The display panel 2, the touch panel 1 and the second sealant 3 enclose a second cavity 4, and an air pressure in the second cavity 4 is less than an atmospheric pressure outside the second cavity 4. It can be understood that a second sealant 3 is disposed between the display panel 2 and the touch panel 1. The display panel 2, the touch panel 1 and the second sealant 3 enclose the second cavity 4. The display panel 2 and the touch panel 1 are also formed into a box structure, and the display panel 2, the air pressure in the second cavity 4 formed by the display panel 2, the touch panel 1 and the second sealant 3 is less than the atmospheric pressure outside the second cavity 4. On the basis of bonding the display panel 2 and the touch panel 1 with the second sealant 3, the air pressure in the second cavity 4 is further lower than the atmospheric pressure outside the second cavity 4 for utilizing the atmospheric pressure. Therefore, the display panel 2 and the touch panel 1 are tightly combined. Specifically, the second cavity 4 between the display panel 2 and the touch panel 1 is in a vacuum state, that is, the display panel 2 and the touch panel 1 are tightly connected by the vacuum edge lamination to ensure that the display panel 2 and the touch panel 1 are not easily separated after being used or bent into a curved display screen.

As mentioned above, in this embodiment, before the display panel 2 and the touch panel 1 are not bent, a distance between the display panel 2 and the touch panel 1 can be adjusted and disposed according to actual needs. Obviously, under the condition that the second cavity 4 between the display panel 2 and the touch panel 1 is in a vacuum state, the display panel 2 and the touch panel 1 are slightly deformed toward the second cavity 4. When the distance between the display panel 2 and the touch panel 1 is too small, it will cause the display panel 2 and the touch panel 1 to bend toward the second cavity 4 and contact each other. When the space between the display panel 2 and the touch panel 1 is too large, the space of the second cavity 4 will be too large, which will increase the technical difficulty of the vacuum edge lamination between the display panel 2 and the touch panel 1, and also increase the overall thickness of the touch display device. Specifically, in this embodiment, the distance between the display panel 2 and the touch panel 1 is 5 um.

In one embodiment, obviously, the difference between the thickness of the touch panel 1 and the thickness of the display panel 2 is supposed to be as small as possible. It can be understood that when the touch panel 1 and the display panel 2 undergo a vacuum edge lamination, obviously, the difference between the thickness of the touch panel 1 and the display panel 2 is supposed to be small, and all forces between the touch panel 1 and the display panel 2 relatively disposed with each other are uniform. When the thickness of the touch panel 1 is much greater than the thickness of the display panel 2, the display panel 2 is prevented from being excessively bent and deformed towards the touch panel 1. Specifically, the thickness of the touch panel 1 is equal to the thickness of the display panel 2.

In an embodiment, as shown in FIG. 8, the display panel 2 is curved in an arc-shaped curved structure, and the touch panel 1 is disposed on a concave side of the display panel 2 in an arc-shaped shape and corresponds to the shape of the touch panel 1. It can be understood that after the display panel 2 and the touch panel 1 undergo the vacuum edge lamination, the display panel 2 and the touch panel 1 as a whole can be bent in a bending process to form a curved screen. It should be noted that when the display panel 2 and the touch panel 1 are bent to one side to form a curved screen, the distance between the display panel 2 and the touch panel 1 is set to be narrow as mentioned above. Specifically, the distance between the display panel 2 and the touch panel 1 is 5 μm, which is advantageous in preventing the excessive misalignment of the metal trace 1221 and the light shielding strip 141 after the touch panel 1 is bent. The alignment accuracy of the metal trace 1221 and the light shielding strip 141 is ensured under bending conditions.

As mentioned above, the light shielding layer 14 is disposed on the package cover plate 11, and the orthographic projection of the light shielding layer 14 projected on the substrate 121 at least partially overlaps the orthographic projection of the touch trace layer 122 projected on the substrate 121, so as to block the light reflected by the touch trace layer 122 by the light shielding layer 14. The reduction in contrast of the overall display of the touch display device caused by the reflection of the touch trace layer 122 in the touch panel 1 can be prevented. The overall display effect of the touch display device is improved.

This disclosure has been described with preferred embodiments thereof, and it is understood that many changes and modifications to the described embodiment can be carried out without departing from the scope and the spirit of the invention.

What is claimed is:

1. A touch panel, comprising:
a package cover plate and a touch substrate disposed opposite to each other; and
a connection layer disposed between the package cover plate and the touch substrate;
wherein the touch substrate comprises a substrate, and a touch trace layer disposed on a side of the substrate close to the package cover plate, and a light shielding layer is disposed on a side of the package cover plate close to the touch substrate; and
wherein an orthographic projection of the light shielding layer on the substrate at least partially covers an orthographic projection of the touch trace layer on the substrate.

2. The touch panel according to claim 1, wherein the touch trace layer comprises at least one metal trace, the light shielding layer comprises at least one light shielding strip corresponding to the metal trace, an orthographic projection of the light shielding strip on the substrate at least partially covers an orthographic projection of the metal trace on the substrate.

3. The touch panel according to claim 2, wherein an orthographic projection of a center line of the light shielding strip on the substrate overlaps an orthographic projection of a center line of the metal trace on the substrate.

4. The touch panel according to claim 2, wherein the orthographic projection of the light shielding strip on the substrate overlaps the orthographic projection of the metal trace on the substrate.

5. The touch panel according to claim 1, wherein the connection layer comprises a first sealant and a transparent filling layer, and the package cover plate, the touch substrate, and the first sealant enclose a first cavity, and the transparent filling layer is disposed in the first cavity.

6. The touch panel according to claim 5, wherein a material of the transparent filling layer is liquid crystal.

7. The touch panel according to claim 5, wherein the touch panel comprises a touch display area and a non-display area disposed around the touch display area, the light shielding layer is disposed in the touch display area, a black blocking wall positioned in the non-display area is disposed on the side of the package cover plate close to the touch substrate, an orthographic projection of the black blocking wall on the substrate covers an orthographic projection of the first sealant on the substrate, a material of the light shielding layer is the same as a material of the black blocking wall, and the light shielding layer and the black blocking wall forms an integrally molded structure.

8. The touch panel according to claim 5, wherein a thickness of the package cover plate is the same as a thickness of the substrate.

9. A touch display device, comprising a display panel, and a touch panel according to claim 1, wherein the touch panel is disposed on one side of the display panel.

10. The touch display device according to claim 9, wherein a second sealant is disposed between the display panel and the touch panel, the display panel, the touch panel and the second sealant are enclosed to form a second cavity, and an air pressure in the second cavity is less than an atmospheric pressure outside the second cavity.

11. The touch display device according to claim 10, wherein the display panel is curved in an arc shape, the touch panel is disposed on a concave side of display panel that is in the arc shape and is corresponding to a shape of the touch panel.

12. The touch display device according to claim 10, wherein a thickness of the touch panel is equal to a thickness of the display panel.

13. The touch display device according to claim 10, wherein the second cavity is in a vacuum state.

14. The touch display device according to claim 9, wherein the touch trace layer comprises at least one metal trace, the light shielding layer comprises at least one light shielding strip corresponding to the metal trace, an orthographic projection of the light shielding strip on the substrate at least partially covers an orthographic projection of the metal trace on the substrate.

15. The touch display device according to claim 14, wherein an orthographic projection of a center line of the light shielding strip on the substrate overlaps an orthographic projection of a center line of the metal trace on the substrate.

16. The touch display device according to claim 14, wherein the orthographic projection of the light shielding strip on the substrate overlaps the orthographic projection of the metal trace on the substrate.

17. The touch display device according to claim 9, wherein the connection layer comprises a first sealant and a transparent filling layer, and the package cover plate, the touch substrate, and the first sealant enclose a first cavity, and the transparent filling layer is disposed in the first cavity.

18. The touch display device according to claim 17, wherein a material of the transparent filling layer is liquid crystal.

19. The touch display device according to claim 17, wherein the touch panel comprises a touch display area and a non-display area disposed around the touch display area, the light shielding layer is disposed in the touch display area, a black blocking wall positioned in the non-display area is disposed on the side of the package cover plate close to the touch substrate, an orthographic projection of the black blocking wall on the substrate covers an orthographic projection of the first sealant on the substrate, a material of the light shielding layer is the same as a material of the black blocking wall, and the light shielding layer and the black blocking wall forms an integrally molded structure.

20. The touch display device according to claim 17, wherein a thickness of the package cover plate is equal to a thickness of the substrate.
